(19) United States
(12) Patent Application Publication
(10) Pub. No.: US 2026/0017527 A1
(43) Pub. Date: Jan. 15, 2026

(54) EXPLAINING ARTIFICIAL INTELLIGENCE DECISIONING WITH TIME SERIES ARTIFICIAL INTELLIGENCE ALLOCATION DATA

(71) Applicant: Claritas, LLC, Cincinnati, OH (US)

(72) Inventor: Jason Rex Briggs, Galena Forrest, NV (US)

(21) Appl. No.: 19/268,820

(22) Filed: Jul. 14, 2025

Related U.S. Application Data
(60) Provisional application No. 63/671,572, filed on Jul. 15, 2024.

(51) Int. Cl. G06N 3/091; G06F 9/451

(52) U.S. Cl. CPC G06N 3/091; G06F 9/451

(57) ABSTRACT

A method comprising identifying one or more differentiating features of a set of content items, wherein at least a subset of the set of content items is allocated according to an optimized allocation pattern; identifying one or more context features associated with the set of content items; identifying, based on at least one of the one or more differentiating features or the one or more context features, one or more insights into the optimized allocation pattern; and providing the one or more insights for presentation on a client device.

### RELATED APPLICATIONS

This application claims the benefit under 35 U.S.C. § 119 (c) of U.S. Provisional Patent Application No. 63/671,572, titled “Explaining Artificial Intelligence Decisioning with Time Series Artificial Intelligence Application Data,” filed on Jul. 15, 2024, the entire content of which is incorporated herein by reference.

### TECHNICAL FIELD

This disclosure relates to the field of artificial intelligence, and in particular to explaining artificial intelligence decisioning with time series artificial intelligence allocation data.

### BACKGROUND

Web content can contain various features, such as a text, an audio, a video, and an image, which can be combined in many different ways. A system can use artificial intelligence (AI) models can determine an optimal allocation of the features to achieve a defined result. Such AI models can be continuously trained, focusing on incremental learning and adapting to new data over time. Continuously trained AI models can operate in real-time (or near real-time), dynamically adjusting various features of the content items to optimize the allocation decisions. However, the reasoning behind the AI's optimization decisions is generally not disclosed to an end user, and even if the AI logic was disclosed, it can be highly complex and non-linear to the point of inscrutability, resulting in a lack of understanding and confidence in the optimization of the allocation of the features.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 illustrates an example of a system architecture for implementations of the present disclosure.

FIG. 2 depicts a flow diagram of a method for identifying an insight into an optimized allocation pattern of a set of content items, in accordance with one or more aspects of the present disclosure.

FIG. 3 illustrates example content items with differentiating features, in accordance with one or more aspects of the present disclosure.

FIG. 4 illustrates a feature tree for a set of content items, in accordance with one or more aspects of the present disclosure.

FIG. 5 illustrates a feature grid for a set of content items, in accordance with one or more aspects of the present disclosure.

FIG. 6 illustrates an example candlestick chart to display the lift provided by AI, in accordance with one or more aspects of the present disclosure.

FIG. 7 illustrates an example waterfall chart displaying AI's incremental lift, in accordance with one or more aspects of the present disclosure.

FIG. 8 illustrates an example time series chart displaying the AI-adjusted allocation pattern of content items over time, in accordance with one or more aspects of the present disclosure.

FIG. 9 illustrates an example baseline interpretation of time series allocation data using weights and differential conversion rates, in accordance with one or more aspects of the present disclosure.

FIG. 10 depicts a block diagram of an example computing system operating in accordance with one or more aspects of the present disclosure.

### DETAILED DESCRIPTION

Embodiments are described for explaining artificial intelligence (AI) decisioning with time series AI allocation data. Time series allocation data refers to the content delivery pattern(s) of AI optimized feature combinations for content items. Allocation data can include the volume the optimization system has allocated to each feature or combinations of features.

Continuously trained AI models can be designed to learn and adapt incrementally over time, building upon previously learned knowledge. A continuously trained AI model may be used to provide adaptive optimization techniques for a content item. A content item can correspond to any form of information provided via a network (e.g., provided via a web page, in an email message, in a text message, in a social media posting, etc.). Within a content item, there may be different types of audiovisual features (e.g., a title, a call to action, an image, a video, an audio, a background image, a message, etc.) laid out in various ways (e.g., on a web page). The optimal combination of features for a content item may achieve a defined result (e.g., a response from a target audience of the content that can be measured by a key performance indicator (KPI)). A continuously trained AI model can provide an adaptive optimization technique for a content item by initially using random combinations of features and using machine learning (ML) models that detect strong data patterns in KPIs associated with the combinations of features, and at the same time gradually training other premature ML models for which data patterns have not yet emerged. This adaptive optimization technique results in one or more ML models that are continuously making decisions and adapting to provide feature combinations for a content item, optimized for current conditions (e.g., user characteristics, device characteristics, detected user actions, etc.).

Such continuously trained AI models may, however, lack transparency surrounding the continuous decision-making of the model. For instance, a user of the AI models may lack visibility in the decisioning of the AI models, which may negatively affect the user's confidence in the models' output and/or performance. Additionally, the lack of transparency may negatively affect the user's overall understanding of the output of the AI models. A user may lack an overall understanding of why a certain combination of features is determined to be optimal by the AI model. Without an understanding of the reasoning behind the AI models' output, the user may lack the necessary data and information to generate new content that is likely to be aligned with the optimal feature combinations. This can lead to an inefficient use of computing resources, both in the creation of new content items that do not align with the optimal feature combinations, and in the execution of the AI models on the newly created content items that do not align with the optimal feature combinations.

Aspects of the present disclosure address the above-noted and other deficiencies by providing an insight component that provides an explanation and/or visualization of an optimization AI model's decision-making process for a set of content items. A set of content items can include content items that are correlated (e.g., that are designed to achieve a similar result, that are part of the same campaign, that have a common theme, etc.). The optimization AI model can be a continuously trained model, trained to determine an optimized allocation, over time, of the content items in the set of content items (sometimes referred to herein as time series allocation data). For example, the optimized allocation can determine when certain content items in the set of content items are to be provided to certain users to achieve a defined result. A defined result can be measured in terms of KPIs, and can include specific defined response action(s) of a target audience of the content items. For example, the response actions can be click-through rate (e.g., the percentage of users that perform an action after being presented the content item; the action can be clicking on a link included in the content item, for example), conversion rate (e.g., the percentage of users that take a desired action after interacting with the content item; the desired action can be making a purchase, for example), impressions (e.g., the number of users that have viewed the content item); etc. The insight component can provide insights into the optimal allocation pattern, e.g., by feature (or combination of features) and/or by feature(s) over time. In some embodiments, the insight component can provide the insights to a user interface of a user device in a manner that is understandable by a human user of the user device. An insight refers to a reason or explanation of the output of the optimization AI model, and can be provided in text format, in a graphical format (e.g., a chart), audio format, and/or in any other suitable format.

In some embodiments, the insight component can begin by identifying the differentiating features of each content item in the set of content items. The insight component can identify the features using metadata of the content item, and/or using a feature identifying AI model that is trained to identify differentiating features of a set of content items. Differentiating features can be features that differ between content items in the set of content items. For example, if each content item in the set has a blue background, the feature identifying AI model may not identify the background color as a differentiating feature. Whereas if some of the content items in the set have a blue background and others have a green background, the feature identifying AI model may identify the background color as a differentiating feature. The insight component may label each content item with the differentiating features, as identified by the metadata and/or by the feature identifying AI model.

In some embodiments, the insight component can also identify contextual data for the set of content items. Contextual data can include, for example, the name of the organization associated with the set of content items, the result of a user interacting with a particular content item (e.g., the website landing page of where users click through), and/or the content of the content items. In some embodiments, a context AI model can identify the contextual data based on the name of the organization associated with the set of content items, based on the website landing page, and/or based on the content of the content items. The context AI model can be a large language model (LLM) that is provided one of the sources as a prompt (e.g., the name of the organization, the content of the content item, the landing page URL of the content item), and can provide, as output, the additional contextual data for the set of content items (e.g., in text format).

In some embodiments, the insight component can also identify additional data relating to the content items. The additional data can be from a news feed and/or an events feed. The additional data can be, for example, news reports published within a time period of the content item allocation. The news reports can be from publications that correspond to the content of the content items, and/or can be from publications that correspond to the location in which the content items are allocated (e.g., geographic locations). For example, for a set of sports-themed content items for a particular sports team in San Francisco, the additional data can be from news reports from San Francisco Bay Area publications and/or from sports pages of nationwide publications, published within a certain time of the allocation of the content items. In some embodiments, the additional data can include weather patterns of the geographic area in which the content items is allocated. Other types of news feeds may also be used. The additional data can be, for example, an events table that includes events and corresponding dates for the events.

In some embodiments, the insight component can provide the identified features, the contextual features, the additional data, and/or the optimized allocation pattern as input to a trained insight AI model. The insight AI model can provide, as output, one or more insights into the optimized allocation pattern. An insight can represent a reason or explanation for an increase or decrease in the optimized allocation pattern. The insight component can provide the one or more insights for presentation on a UI of a user device. For example, the insight component can generate charts to illustrate the insight in the allocation pattern over time, or can display the insight as text on the UI of the user device.

In some embodiments, the insight component can create a control group on which the optimization AI model will not run. In some embodiments, the control group can be provided a portion of the set of content items (e.g., 10% of the content items in the set of content items). The portion of the set of content items can include a randomized combination of features. For example, the insight component can divide the content items in the set of content items into equal randomized rotation. The insight component can execute the optimization AI model on the content items not in the control group, and can compare the results of the content items on which the optimization AI model executed to the results of the content items in the control group. The results can be, for example, in terms of conversion rate. Conversion rate can be described as the percentage of users that take a desired action after interacting with the content item (e.g., the percentage of users that fill out a form, sign-up for a program, or make a purchase after clicking on a link included in the content item). The insight component can determine the difference between the result of content items allocated based on the optimization AI model and the result of content items allocated not based on the optimization AI model. The insight component can provide a visualization of the difference between the two, e.g., in a chart, based on the identified features of the content items, and/or based on the features over time.

In some embodiments, the insight component can provide one or more recommendations for future content item creation based on the one or more insights, and can provide the one or more recommendations for presentation on the client device. The recommendations can include, for example, a specific feature combination to use in a future set of content items, based on the identified insights.

Aspects of the present disclosure provide technical advantages including reduced usage of computing resources used for generating content items and in the execution of AI models that determine an optimal combination of features for the content items. The systems and methods described herein can combine human-encoded and AI-extracted features, e.g., leveraging computer vision and large language models to identify and classify differentiating features among content items in a set of content items. The systems and methods described herein can further contextualize the optimized allocation pattern of the set of content items by integrating external data sources, such as news and events feeds, and by analyzing additional data corresponding to the set of content items (e.g., landing pages, brand data, etc.). Using this contextual understanding, the system and methods described herein can correlate shifts in AI allocation with real-world events or trends, which can provide insights and explanations for changes in content performance, which can lead to enhanced transparency, improved user confidence in AI-driven optimization, and actionable recommendations for creating content items. Thus, the actionable recommendations for creating content items based on the identified insights can enable more efficient content creation, and reduce computing resources used by AI models to analyze and optimize generated content.

Aspects of the present disclosure can result in streamlined content creation by providing actionable insights into which specific features or combinations of features drive optimal performance in AI-optimized sets of content items. By systematically extracting and labeling differentiating features form content items (e.g., using metadata and/or AI model(s) such as computer vision or LLMs), the system can identify precise features (e.g., images, headlines, calls-to-action, etc.) that influence the performance results of the AI-optimized content items (e.g., based on user engagement and conversion rates). This granular understanding can allow content creators to focus their efforts on developing new content that aligns with proven, high-performing feature combinations, rather than relying on guesswork or broad experimentation. Furthermore, the method and system's ability to generate human-understandable explanations and/or visualizations of AI allocation decisions over time can help creators to quickly discern which creative features are effective under varying conditions, such as different times of day or in response to external events. As a result, the content creation process can become more targeted, data-driven, and efficient, reducing wasted efforts on ineffective variations and accelerating the development of impactful campaigns.

Additionally, aspects of the present discourse enhance resource allocation by introducing a robust, data-driven framework for evaluating the effectiveness of AI-optimized versus non-optimized content. The user of a randomized control group (e.g., where a portion of content is delivered without AI optimization) establishes a baseline for performance comparison. This can enable organizations to quantitatively assess the incremental lift provided by AI, ensuring that resources are allocated to content strategies that demonstrably improve key performance indicators, such as conversion rates or user engagement. Additionally, the system's automated insight generation, which can incorporate contextual data, allows for dynamic adjustment of content delivery in real time. By continuously monitoring and visualizing allocation patterns and performance outcomes, the systems and methods descried herein can help organizations reallocate resources toward the most effective content features and feature combinations. This can reduce the computational overhead associated with running and testing suboptimal content, leading to more efficient use of technological resources.

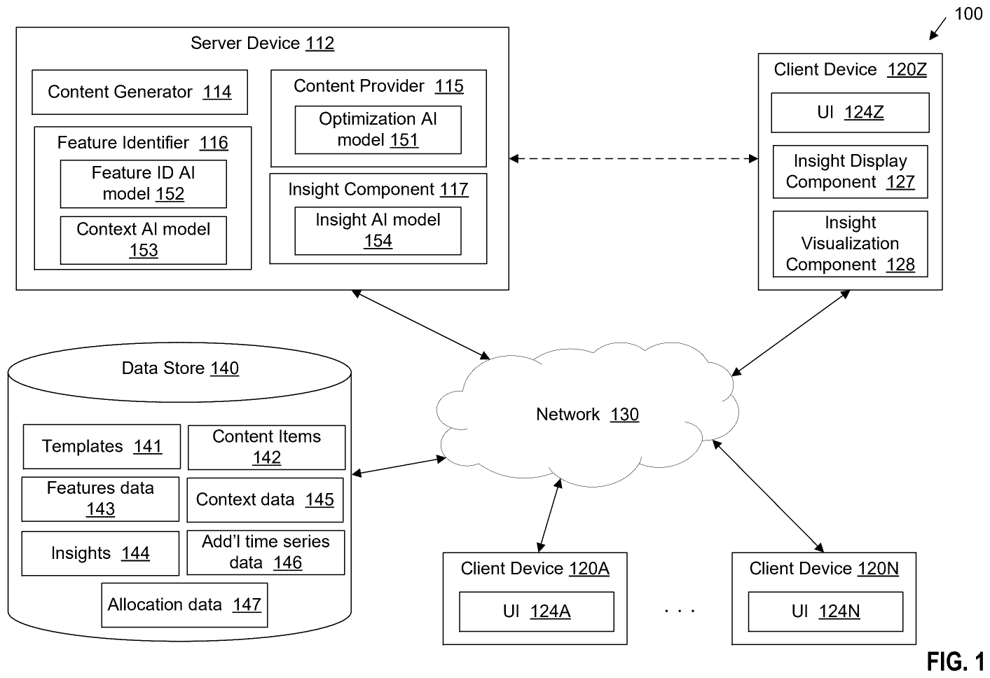

FIG. 1 illustrates an example of a system architecture 100 for implementations of the present disclosure. The system architecture 100 includes a server device 112, a data store 140, and/or client devices 120A-Z connected via a network 130. The network 130 may be one or more public networks (e.g., the Internet), private networks (e.g., a local area network (LAN) or wide area network (WAN)), or a combination thereof. The network 130 may include a wireless infrastructure, which may be provided by one or more wireless communications systems, such as Wi-Fi hotspot connected with the network 130 and/or a wireless carrier system that can be implemented using various data processing equipment, communication towers, etc. Additionally or alternatively, the network 130 may include a wired infrastructure (e.g., Ethernet). In some embodiments, the network 130 can be a single network.

In some embodiments, data store 140 can be a persistent storage that is capable of storing templates 141, content items 142, features data 143, context data 145, insights 144, additional time series data 146, and/or allocation data 147. Data store 140 may be hosted by one or more storage devices, such as main memory, magnetic or optical storage based disks, tapes or hard drives, NAS, SAN, and so forth. In some implementations, data store 140 may be a network-attached file server, while in other embodiments data store 140 may be some other type of persistent storage such as an object-oriented database, a relational database, and so forth, that may be hosted by server device(s) 112, and/or client device(s) 120A-Z. In some embodiments, data store 140 may be hosted by or one or more different machines coupled to the server device 112, and/or user device 120A-Z.

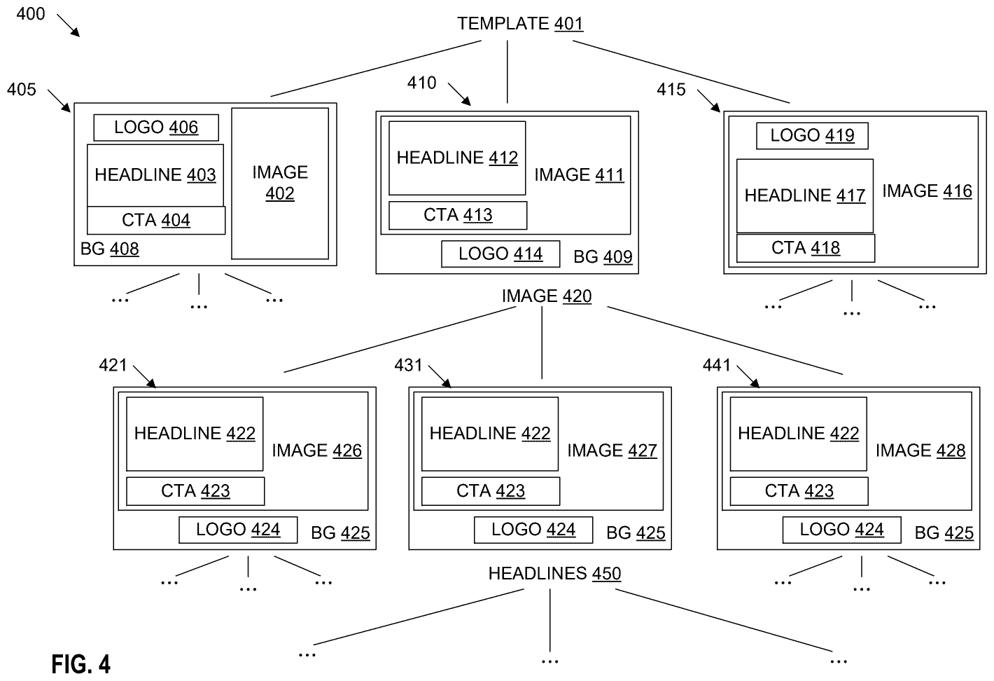

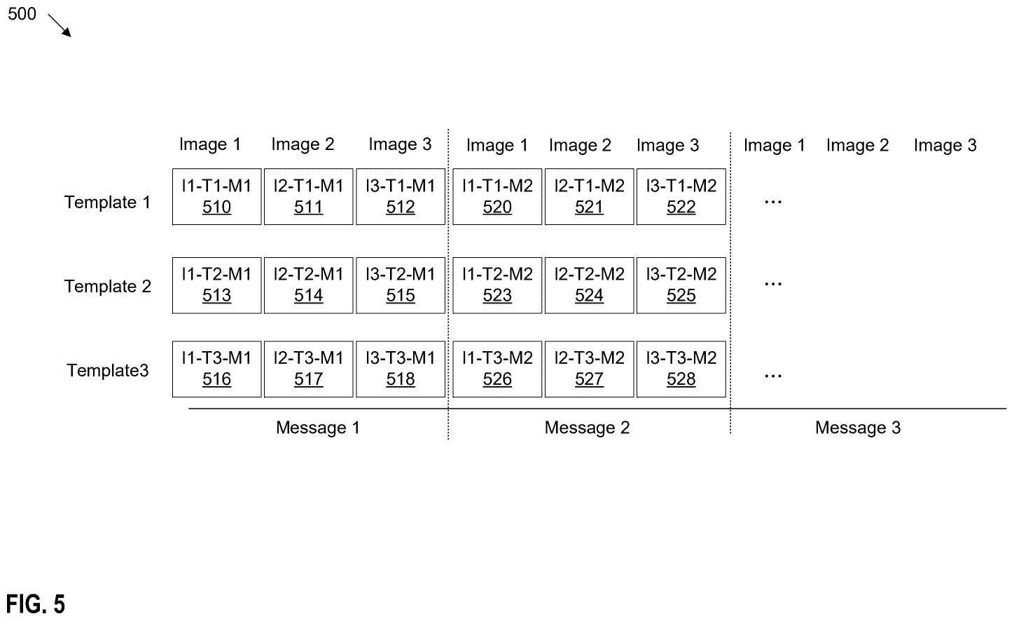

In some embodiments, templates 141 can include predefined structural frameworks used to generate content items with various differentiating features. Each template can specify an arrangement of features that can be included in a content item, such as the placement of an image, a headline, a call-to-action, a background color, and/or other creative elements. Templates 141 can serve as the foundational building blocks for creating multiple variations of content by allowing different combinations of features. For example, a template might define a layout where an image appears at the top, followed by a headline, and a call-to-action button. Example templates are described with respect to FIGS. 4-5. By swapping out the specific image, headline, or call-to-action within the same template, the content generator 114 can generate a variety of content items that are structurally similar but differ in their creative details. In some embodiments, templates 141 can be encoded at the time of content creation. Additionally or alternatively, templates 141 can be identified by an AI model (e.g., feature identifying AI model 152), e.g., using computer vision and/or feature classification. Templates 141 can be organized in a feature tree (e.g., as described with respect to FIG. 4) or a feature grid (e.g., as described with respect to FIG. 5), to facilitate tracking, comparing, and/or optimizing the performance of different content variations with a set of content items.

In some embodiments, content items 142 can include content items generated by content generator 114, and/or received by server device 112. The content items 142 can store sets of content items. Each set of content items in content items 142 can be a group of correlated content items. For example, a set of content items can include content items that are designed to achieve a similar result (or results), that are part of the same campaign, that have a common theme, and so on. A content item can correspond to any form of information provided via a network 130 (e.g., provided via a web page, in an email message, in a text message, in a social media posting, etc.). Each content item in content items 142 can include different types of features (e.g., a title, a call-to-action, a message, an image, a video, an audio, a background image, a background color, a font, a font size, a font color, etc.) laid out in various ways (e.g., according to a template of templates 141).

In some embodiments, features data 143 can include data that indicates the differentiating features in the content items 142. Differentiating features can be features that differentiate one content item from another content item. Differentiating features can include, for example, a title, a call-to-action, a message, an image, a video, an audio, a background image, a background color, a font, a font size, a font color, and so on. In some embodiments, the differentiating features can be stored as metadata for each particular content item.

In some embodiments, context data 145 can include data indicating contextual features for a content item of content items 142, and/or for a set of content items of content items 142. The contextual features can include, for example, additional information that is related to the content item or set of content items, such as data from the landing page to which clicking on the call to action will lead a user, information on the organization(s) associated with the content items in the set of content items, and/or the content of the content items in the set of content items.

In some embodiments, insights 144 can include the insights into a particular AI-optimized allocation pattern of content items 142. The insights can provide an explanation and/or visualization of the AI-optimized allocation pattern. Insights 144 can be identified by insight component 117. In some embodiments, insights 144 can include human-understandable explanations or reasons that clarify the patterns, rationale, and/or factors underlying the optimization AI model's allocation of content items and/or feature combinations. The insights 144 can enhance transparency, support user understanding, and/or provide actionable guidance regarding the optimization AI's decision-making process in content item allocation optimization.

In some embodiments, additional time series data 146 can include chronological datasets that are associated with, but distinct, from the optimization AI's allocation data. The additional time series data 146 can include external information that varies over time that may influence or help explain the optimization AI models' allocation pattern and optimization decisions. Examples of additional time series data 146 can include news feeds, events, feeds, weather patterns, and/or other chronological contextual data (e.g., any time-stamped data sources that provide time series context for interpreting shifts or trends in the optimization AI model's allocation of content items, such as social media trends, economic indicators, and/or campaign-specific milestones). News feeds can include chronologically ordered news reports and/or articles published within the same time frame as the content item allocations. These can be, for example, general news, industry-specific updates, and/or geographical relevant stories that may impact user behavior or content performance. Events feeds can include, for example, timelines of relevant events (e.g., sports games, product launches, and/or public holidays) with corresponding dates, which may correlate with changes in content item allocation and/or user engagement. Weather patterns can include, for example, time-stamped weather data for the geographic areas where content is being delivered, which can affect user activity and/or content effectiveness.

In some embodiments, allocation data 147 can include a chronological record of how content items 142 are allocated over time, based on various feature combinations and/or optimization objectives (e.g., key performance indicators). Allocation data 147 is sometimes referred to as time series allocation data. Allocation data 147 can include which content items 142 (or, in some cases, which feature combinations of content items 142) are delivered, to whom, and when. The allocation data 147 can be tracked and recorded at regular intervals (e.g., hourly, daily), creating a sequence of data points that reflect the allocation over time. In some embodiments, allocation data 147 can be chronological in structure, feature-based, and can include volume and performance metrics. In some embodiments, allocation data 147 can reflect the output of an AI-optimized allocation.

The server device 112 may be represented by one or more physical machines (e.g., server machines, desktop computers, etc.) that include one or more processing devices communicatively coupled to memory devices and input/output (I/O) devices. In some embodiments, the server device 112 may receive requests for content items from one or more content providing servers (not pictured). A content item can correspond to an item visually or aurally presented on a web page supported by the content providing servers. Examples of a content item can include a personalized advertisement, media (a video or music) or consumer electronics recommendation, a landing page, a check out page, a packaging or a cover design, an email or a text message content, message of a physical mail, a video for a television, and so on.

In some embodiments, server device 112 includes a content generator 114, a content provider 115, a feature identifier 116, and/or an insight component 117. In some embodiments, the content generator 114 can process the received requests and generate content items for the requests. In some embodiments, the generated content items can be stored as content items 142. In some embodiments, the generated content items can correspond to templates 141. In some embodiments, the server device 112 may receive generated content items from one or more content generating servers (not pictured), and may store the received generated content items as content items 142.

In some embodiments, the content provider 115 can provide the generated content items for presentation to client devices 120A-Z. The content provider 115 can identify an allocation pattern for a set of content items 142, e.g., stored as allocation data 147. The allocation pattern can determine which content items 142 to provide to which client device 120A-Z and at what time, for example. In some embodiments, the content provider 115 can implement an optimization AI model 151 that optimizes the allocation of the set of content items 142. That is, the optimization AI model 151 can identify a feature or feature combination to include in a content item (or set of content items) to be presented to a particular demographic (e.g., target audience) during a particular time period, in order to achieve a defined result. The output of the optimization AI model 151 is sometimes referred to herein as time series allocation data. As an illustrative example, the content provider 115 may provide a web page or any other medium that contains various contents, e.g., generated by content generator 114, to the client devices 120A-120Z. Examples of contents includes a personalized advertisement, media (a video or music) or consumer electronics recommendation, a landing page, a check out page, a packaging or a cover design, an email or a text message content, message of a physical mail, a video for a television. In some embodiments, server device 112 may gather characteristics about target audiences of the client devices 120A-120Z. Such characteristics can include demographic information (such as, an age or a gender), contextual information (such as, a brand of the client devices 120A-120Z, an operating system of the client devices 120A-120Z, a time zone, a geographic location), historical (or user behavioral) features (such as, a number of impressions, time since the last impression, a number of clicks).

In some embodiments, a training engine can train the optimization AI model. In one embodiment, the training engine can periodically train the optimization AI model in multiple phases (e.g., continuously trained), thereby increasing model accuracy as more training data accumulates. The training engine can train the optimization AI model to solve a probability or score estimation problem (e.g., whether a content item associated with the optimization AI model is most likely to achieve a response action from a target, e.g., measured by a KPI). The training engine may find patterns in training data (including training input and training output) that map the training input to the target output (i.e., the answer to be predicted) and provide the optimization AI model that captures these patterns under supervised learning. Accordingly, the trained optimization AI model can predict a probability of a target audience having a respective set of input characteristics performing a target action (such as, a click) in response to being presented with a respective content item.

In one embodiment, the optimization AI model can be trained based on a limited number of training data, such as a couple of thousands sets of training data or the training data collected over a couple of days (e.g., based on responses to randomly or pseudo-randomly generated content items). The server device 112can include a training engine that is capable of training an AI model. The training engine may find patterns in training data (including training input (sometime, referred to as features) and training output (sometimes, referred to as a target label or target output)) that map the training input to the training output (i.e., the answer to be predicted) and provide the AI model that captures these patterns under supervised learning. Such an AI model can correspond to a model artifact that is created by the training engine that uses training data (e.g., training inputs and corresponding training outputs (e.g., correct answers for respective training inputs)). The AI model may be composed of, e.g., a single level of linear or non-linear operations based on logistic regression or gradient boosting technique.

In one implementation, the training engine can utilize a reliability criterion that is associated with at least one of a mean or a standard deviation of an area under the ROC (receiver operating characteristic) curve that is generated using one or more sets of validation data with the optimization AI model. The validation data can include validation input data as a set of characteristics associated with a target and validation output data as an indication of whether or not a target action was performed. For example, the server device 112 can use a multi-fold cross-validation technique. Accordingly, for each fold (e.g., each set of validation data), the processing device can determine an area under ROC curve (referred to as the area under the curve, or “AUC”). Based on the AUC, the server device 112 can determine a mean and standard deviation of the AUC. Subsequently, the server device 112 can determine that a trained optimization AI model satisfies a reliability criteria in response to determining that a) a difference between the mean and standard deviation of the AUC is greater than a threshold value (e.g., 0.5) and b) the standard deviation of the AUC is equal to or less than a threshold value (e.g., 0.1). If the trained optimization AI model satisfies the reliability criteria, the training engine can determine that the optimization AI model is trained. In some embodiments, the training engine can continue to train the trained optimization AI model as more training data is generated.

The server device 112 may receive requests for web contents and/or other content items from the client devices 120A-120Z, and content generator 114 may generate a content item in response to the request. Alternatively, or additionally, the server device 112 may generate content without first receiving requests for content from the client devices 120A-Z.

In some embodiments, the content generator 114 may generate content items based on the requests and provide the content items to the client devices 120A-120Z. Different content items may be provided to different client devices 120A-Z based at least in part on the characteristics associated with those different client devices 120A-Z, and/or respective users of the client devices 120A-Z. Responsive to receiving the content items, client devices 120A-120Z may or may not receive user interaction with the content items, which may be associated with KPIs. Furthermore, the server device 112 may receive responses to the presented content items from the client devices 120A-120Z. The server device 112 may provide the responses to the content generator 114, content provider 115, and/or to the insight component 116.

Each client device 120A-120Z may include one or more processing devices communicatively coupled to one or more memory devices and one or more I/O devices. The client devices 120A-120Z may be desktop computers, laptop computers, tablet computers, mobile phones (e.g., smartphones), or any suitable computing device. In some embodiments, the client devices 120A-120Z may each include a web browser and/or a client application (e.g., a mobile application or a desktop application) for viewing contents (including content items) provided by the content server device 112 via user interfaces 124A-124Z supported by a web browser and/or a client application.

In some embodiments, the feature identifier 116 can identify differentiating features in a set of content items 142. The differentiating features can be features of a content item that differ from other content items in the same set of content items. A set of content items can include multiple content items that share a commonality. For example, a set of content items can include content items that are part of the same campaign (e.g., a marketing campaign). A campaign can define a set of content items that have a coordinated message and call-to-action that achieve a specific objective within a particular timeframe, for example. The set of content items of a campaign can include multiple forms of media and/or communication channels to reach a targeted audience, to increase awareness for a particular subject matter, to generate interest, and/or to drive specific actions (e.g., sign-ups for a particular program). Examples of differentiating features can include background color, call to action text, image displayed, location of image displayed, location of the call to action, font, font color, font size, message text, location of message, etc. In some embodiments, each content item may have associated metadata that identifies the differentiating feature(s) of the corresponding content item. In such embodiments, the feature identifier 116 can identify the differentiating features from the metadata.

In some embodiments, the feature identifier 116 can be or implement a feature identifying AI model 152 to identify the differentiating features of a set of content items. The feature identifying AI model 152 can be trained using supervised or unsupervised training methods. In some embodiments, the feature identifying AI model can be a differentiation classifier (e.g., a trained machine learning model) that categorizes the content items into one or more classes according to differentiating feature(s). In some embodiments, the feature identifying AI model can be trained using a labeled dataset of content items, labeled with differentiating feature(s). The feature identifying AI model 152 can implement computer vision tasks to process and/or analyze the content items in the set of content items, in order to extract differentiating features between the content items in the set. Differentiating features can be visual features that differ between at least two content items in the set. As an illustrative example, if every content item in the set has a black background, the background color may not be identified as a differentiating feature by the feature identifying AI model. If however, the background color differs between at least two content items in the set, the feature identifying AI model can identify the background color as a differentiating feature. In some embodiments, the feature identifier 116 can label each content item according to the identified differentiating feature(s). In some embodiments, the feature identifier 116 can store the differentiating features in data store 140 (e.g., as features data 143).

In some embodiments, the feature identifier 116 can identify the differentiating features based on metadata associated with each content item in the set of content items. For example, for content items generated by content generator 114, the content generator 114 may have stored metadata for each content item identifying one or more differentiating features. In some embodiments, the feature identifier 116 can use the metadata to identify the differentiating feature(s) in addition to implementing the feature identifying AI model to identify additional differentiating feature(s) that may not be identifiable in the metadata.

In some embodiments, the feature identifier 116 can identify contextual features for a set of content items. Contextual features can include, for example, data from the landing page to which clicking on the call to action will lead a user, information on the organization(s) associated with the content items in the set of content items, and/or the content of the content items in the set of content items. In some embodiments, the feature identifier 116 can implement a context AI model that is trained to provide contextual features for the set of content items. In some embodiments, the context AI model can be a generative AI model. The context AI model can be trained using supervised and/or unsupervised learning. In some embodiments, the context AI model can be a large language model (LLM). The feature identifier 116 can provide the context AI model with the name of the organization(s) associated with the set of content items, and the context AI model can output information describing the organization(s). The feature identifier 116 can provide the context AI model with the website landing page of where a user's click-through leads (e.g., a URL), and the context AI model can output information gathered from or based on the landing page. The feature identifier 116 can provide the content of the set of the content items as input to the context AI model, and the context AI model can provide, as output, additional contextual information related to the set of the content items (e.g., the context AI model can identify a car in the content item, and can return information relating to cars, and/or to the specific make and model of the car in the set of content items). In some embodiments, the feature identifier 116 can store the contextual features in data store 140 (e.g., as context data 145).

In some embodiments, the insight component 117 can be, or implement, an insight AI model 154 that is trained to identify one or more insights into the optimized allocation of a set of content items. The insight AI model can be trained using supervised and/or unsupervised learning techniques. In some embodiments, insight AI model can be a generative AI model (e.g., an LLM). In some embodiments, the insight component 117 can provide, as input to the insight AI model 154, the optimized allocation of the set of content items (e.g., as determined by content provider 115), the differentiating features, the contextual features, and/or additional data associated with the set of content items. In some embodiments, the additional data can be received, e.g., from a client device 120Z and/or from another server device (not pictured). In some embodiments, the insight component 117 can identify the additional data. The additional data can be, for example, a news feed, an events feed, an events table, and/or news reports published within a time period of the content item allocation. The news reports can be from publications that correspond to the content of the content items, and/or can be from publications that correspond to the location in which the content items are allocated (e.g., geographic locations). For example, for a set of sports-themed content items for a particular sports team in San Francisco, the additional data can be from news reports from San Francisco Bay Area publications and/or from sports pages of nationwide publications, published within a certain time of the allocation of the content items. An events table can be a set of events and corresponding dates related to the content items. In some embodiments, the additional data can include weather patterns of the geographic area in which the content items are allocated. In embodiments, the insight AI model can provide, as output, data (e.g., events, trends, etc.) from the additional data with the differentiating features and may output indicators as to why particular differentiating features were selected by the optimization AI model at or around a particular time period.

The insight AI model 154 can output one or more insights into the optimized allocation of the set of content items. An insight can represent a reason or explanation for the allocation of the set of content items. For example, the insight AI model 154 can identify a correlation between an increase in the allocation of a particular content item in the set of content items with a particular additional data item (e.g., with a particular news story and/or event on a subject matter related to the content item that occurred near the time of the news story and/or event). The insight AI model 154 can provide one or more insights based on features and/or features over time. In some embodiments, the insight component 117 can provide the output to insight display component 127 and/or insight visualization component 128 of client device 120Z.

In some embodiments, the server device 112 can include a training set generator that can generate training data (e.g., a set of training inputs and target outputs) to train an AI model (e.g., the feature identifying AI model 152, the context AI model 153, and/or the insight AI model 154). In some embodiments, the training data set(s) can be stored in data store 140. In some embodiments, the training data sets can include a corpus of data, such as textual data, image data, and/or audio data. The training data sets can also include mapping data that maps the training inputs to target outputs. The training inputs can include, for example, one or more content items (including differentiating features, the images and/or text included in the content item(s), corresponding time series allocation data, the URL of the landing page associated with the content item, and/or the name of the organization associated with the content item, etc.), and the training outputs can include data representing target outputs (e.g., differentiating features, contextual data, and/or insight data).

In some embodiments, one or more of the AI models (e.g., the optimization AI model 151, the feature identifying AI model 152, the context AI model 153, and/or the insight AI model 154) can be or include a pre-trained foundational model, and a training engine can fine-tune one or more of the AI models on data pertaining to the content items, to generate more specific, or targeted, models. A foundational model can be a large, pre-trained model (such as a large language model or a computer vision model) that is trained on vast, diverse datasets to learn general representations and patterns across a wide range of domains. In some embodiments, a foundational model can include deep neural network architectures, such as transformer networks for language and/or convolutional neural networks for vision tasks. Fine-tuning a foundational model can involve taking the pre-trained model and further training it on a smaller, domain-specific dataset to adapt its capabilities to a particular application or context. For example, the feature identifying AI model can fine-tune (e.g., further train) a computer vision based foundational model using a training dataset that includes content items as described throughout. As another example, the insight AI model can fine-tune (e.g., further train) an LLM foundational model using a training dataset that includes optimized allocation patterns for sets of content items. During fine-tuning, the foundational model's parameters can be adjusted to retain general knowledge from pre-training while specializing in the new domain. In some embodiments, the fine-tune training can be supervised, unsupervised, reinforced, or any other type of training. In some embodiments, the fine-tuning can include some elements of supervision, including learning techniques incorporating human or machine-generated feedback, undergoing training according to a set of guidelines, or training on a previously labeled set of data, etc. In some embodiments, the output of one or more of the AI models, during training, may be ranked by a user, according to a variety of factors (e.g., accuracy, acceptability, or any other metric useful in the fine-tuning portion of the training). The AI model can thus learn to favor these and any other factors relevant to users within an organization, or associated with a content item, when generating an output. In some embodiments, each AI model (e.g., the feature identifying AI model, the context AI model, and/or the insight AI model) can include one or more pre-trained or fine-tuned models.

In one embodiment, the one or more AI models (e.g., the optimization AI model 151, the feature identifying AI model 152, the context AI model 153, and/or the insight AI model 154) can be or include one or more of decision trees, random forests, support vector machines, or other types of machine learning models. In one embodiment, the one or more AI models (e.g., the optimization AI model 151, the feature identifying AI model 152, the context AI model 153, and/or the insight AI model 154) can be one or more artificial neural networks (also referred simply as a neural network). The artificial neural network can be, for example, a convolutional neural network (CNN) or a deep neural network. In one embodiment, processing logic performs supervised machine learning to train the neural network. In some embodiments, one or more of the AI models can be combined into a single AI model.

In some embodiments, one or more of the AI models (e.g., the optimization AI model, the feature identifying AI model, the context AI model, and/or the insight AI model) can be or include a generative AI model. A generative AI model can be trained to learn the underlying distribution of data to generate new outputs, such as text, images, audio, and/or other content, that are statistically similar to the training data. A generative AI model can synthesize new content, fill in missing information, and/or simulate realistic data to generate human-like language, realistic images, music, videos, etc. A generative AI model can be trained using a deep neural network, such as transformed-based models, convolutional neural networks, generative adversarial networks (GAN), and/or variational autoencoders. A generative AI model can include layers of interconnected artificial neurons that process input data and learn complex patterns through backpropagation and gradient descent. The training objective for a generative AI model can be to minimize the difference between generated outputs and real data, e.g., using loss functions such as cross-entropy (for language models) or adversarial loss (e.g., for GANs). The generative AI model can be trained using large and diverse datasets, such as billions of words from books, articles, websites, and/or images. The generative AI model can be pre-trained to learn general representations from broad data, and then fine-tuned to adapt to specific tasks using smaller, target datasets. For example, a pre-trained generative AI model can be fine-tuned to provide contextual data for a set of content items or provide insights for an allocation pattern for a set of content items.

In some embodiments, one or more of the AI models (e.g., the optimization AI model, the feature identifying AI model, the context AI model, and/or the insight AI model) can be or include a large language model (LLM). LLMs are a class of generative AI models designed to process, understand, and generate human language at scale. An LLM can be trained on a large amount of text data to understand and generate human-like language. An LLM can perform various tasks, such as answering questions, summarizing text, translating languages, and/or creating content. An LLM can be built using deep learning architectures, such as transformer neural networks, and are trained on vast corpora of text data to learn the statistical relationships, structures, and contextual nuances of language. A transformer neural network can use mechanisms such as self-attention and multi-head attention to model dependencies between words or tokens in a sequence. Input text can be broken down into tokens (e.g., words, subsets of words, or characters), which can be converted into numerical vectors (e.g., embeddings) that the LLM can process. The LLM can consist of multiple layers of attention and feed-forward networks. Each layer can refine the representation of the input tokens, allowing the LLM to build a hierarchical understanding of the language. The LLM can perform text generation, in which the LLM predicts the probability distribution of the next token in a sequence, given the preceding context. This process can be repeated iteratively to generate coherent and contextually appropriate text. The LLM can be trained using supervised and/or unsupervised learning. The LLM's parameters (e.g., weights) can be updated using an optimization algorithm. Backpropagation can be used to compute gradients of the loss function with respect to the model parameters, enabling the LLM to learn from its errors. After initial pre-trainings, the LLM can be fine-tuned on domain-specific data to improve performance on specialized tasks. Fine-tuning can involve additional training on a smeller, targeted dataset, e.g., with supervised objectives. In some embodiments, a pre-trained LLM can be fine-tuned using a set of content items, contextual data, allocation data, and/or other data described herein to interpret the content of a set of content items, synthesize contextual information from various data sources (e.g., organization names, website content, news feeds, etc.), and/or generate human-understandable explanations for AI-optimized allocations of content items.

In some embodiments, one or more of the AI models (e.g., the optimization AI model 151, the feature identifying AI model 152, the context AI model 153, and/or the insight AI model 154) can be or include a discriminative AI model. A discriminative model can be designed to model the conditional probability of an output given specific input data, effectively learning the boundaries between different classes of data to make predictions and classifications for new, unseen data. For instance, a discriminative model can be implemented as a classifier that distinguishes between various categories or features within a dataset, assigning input data to the most appropriate class based on learned patterns. Common examples of discriminative models can include support vector machines, random forests, and various types of neural networks, such as convolutional neural networks or multilayer perceptrons, which can be trained to optimize classification accuracy by minimizing a suitable loss function (e.g., cross-entropy loss).

As an illustrative example, the feature identifying AI model 152 can be or include a discriminative model that is trained to analyze a set of content items and identify differentiating features that distinguish one content item from another. For example, the feature identifying AI model 152 can use computer vision techniques to classify visual elements (e.g., background color, call-to-action text, etc.) and assign labels to each content item based on these features. By learning to recognize and classify differentiating features, the feature identifying AI model 152 can enable the feature identifier 116 to organize and analyze content items according to their unique attributes. As another illustrative example, the context AI model 153 can use discriminative model techniques to extract and classify contextual information, e.g., from landing pages or organizational data, in embodiments. As another illustrative example, in some embodiments, the insight AI model 154 can leverage discriminative model techniques to identify patterns or correlations in allocation data that are relevant for generating human-understandable insights.

In some embodiments, the feature identifying AI model 152 can be implemented as a supervised classifier, such as a convolutional neural network for image-based features and/or a transformer-based model for text-based features. The classifier can be trained on a labeled dataset of content items. The function of the feature identifying AI model 152 can be to detect and label features that vary across a set of content items, including, for example, different templates, headlines, images, calls-to-action, etc. In some embodiments, the feature identifier 116 can leverage the feature classification provided by the feature identifying AI model 152 to create feature trees or grids (e.g., as described with respect to FIGS. 4, 5) that map the structure of the content variations within a set of content items. The structure feature information (e.g., feature tree or grid) can be used by other components (e.g., the insight component or the insight AI model) to interpret allocation patterns, compare performance across feature combinations, and generate human-understandable insights into the allocation pattern. In some embodiments, the feature identifying AI model 152 can incorporate supervised, unsupervised, and/or semi-supervised learning to discover new differentiating features.

In some embodiments, the feature identifying AI model 152 can implement a classifier, e.g., a type of AI or machine learning (ML) model designed to assign input data to one or more categories or classes. The classifier can analyze input data (e.g., images, text, other data) and determine which class or label (e.g., corresponding to differentiating features) best describes the data based on patterns it has learned during training. The classifier can be trained using supervised learning and/or unsupervised learning. Examples of classifiers include decision tree classifier (e.g., the classifier can split data into branches based on feature values, making decision at each node to classify the input), random forest classifier (e.g., an ensemble method that can build multiple decision trees and combine their outputs to improve classification accuracy and reduce overfitting), support vector machine classifier (e.g., a classifier that can find the optimal boundary (hyperplane) between classes in a high-dimensional space), convolutional neural network classifier (e.g., a deep learning model well-suited for image data, which can form the basis for computer vision-based differentiation classification and/or segmentation), k-nearest neighbors classifier (e.g., classified input data based on the majority class among its k closest neighbors in the feature space), naïve bayes classifier (based on Bayes' theorem and often used for text classification), and transformer-based classifier (e.g., a deep learning model architecture that processes sequential data including text and/or images).

In some embodiments, the feature identifying AI model 152 can implement a classifier (e.g., convolutional neural network) that performs segmentation tasks, such as semantic segmentation and/or instance segmentation. For example, the feature identifying AI model 152 can perform semantic segmentation by labeling each pixel or group of pixels in a content item as belonging to one or more differentiating feature classes (e.g., background, text, call-to-action, etc.). As another example, the feature identifying AI model 152 can perform instance segmentation by identifying and separating multiple instances of the same feature type within a single content item. The segmentation capability of the feature identifying AI model 152 can enable the feature identifier 116 to localize and distinguish between multiple features within a single content item.

In some embodiments, one or more of the AI models (e.g., the optimization AI model 151, the feature identifying AI model 152, the context AI model 153, and/or the insight AI model 154) can implement computer vision techniques. For example, one or more of the AI models based (e.g., the optimization AI model 151, the feature identifying AI model 152, the context AI model 153, and/or the insight AI model 154) can include a computer vision-based differentiation classifier. In some embodiments, the feature identifying AI model 152 can include a computer vision based differentiation classifier that is designed to analyze a set of content items and identify, abstract, and/or label the features that differentiate one item from another within that set. The computer vision based differentiation classifier may not necessarily catalog every feature present in each content item, but rather may focus on features that vary across the set, which are more relevant for understanding, optimizing, and/or explaining AI-driven content allocation decisions. The computer vision based differentiation classifier can use computer vision techniques (such as convolution neural networks) to extract candidate features form each item, such as background color, background image, presence and/or location of a logo, call-to-action text, images, templates, etc. The computer vision based differentiation classifier can determine which feature(s) are invariant (e.g., the same across all items) and which are variant (e.g., differentiating). For example, if each content item in the set of content items has a blue background, the background color feature is not labeled as a differentiating feature. If some content items have a blue background and others have a yellow background, the background color is labeled as a differentiating feature and/or the specific value (e.g., blue or yellow) is assigned to each item. The computer vision based differentiation classifier can output a structured set of labels for each content item. The labels can identify the differentiating features within the set of content items.

In some embodiments, the feature identifying AI model 152 can be trained using supervising learning (e.g., trained on a labeled dataset of content items, where differentiating features have been annotated by humans), unsupervised learning (e.g., trained on an unlabeled dataset of content items and learns to cluster or separate items based on feature differences), and/or semi-supervised learning (e.g., initially trained using supervised learning followed by unsupervised learning to new, unlabeled content items). The feature identifier 116 can provide a set of content items (e.g., images, optionally including associated metadata) as input to the trained feature identifying AI model 152, and the feature identifying AI model 152 can provide, as output, one or more labels corresponding to differentiating features for content items within the set of content items. In some embodiments, the output of the feature identifying AI model 152 can be stored as structured metadata, e.g., as feature data 143.

In some embodiments, insight component 117 can identify a control group of content items on which the optimization AI model did not run. The control group can include a subset of the content items for which the allocation was not optimized by the optimization AI model. The insight component 117 can identify the performance of the content items in the control group to the content items not in the control group (e.g., content items for which the allocation was optimized by the optimization AI model). In some embodiments, the insight component 117 can provide the comparison to the insight display component 127 and/or the insight visualization component 128.

In some embodiments, user device 120Z may include an insight display component 127 and/or an insight visualization component 128. Insight display component 127 can receive insights from insight component 117, and can provide the received insights for presentation on UI 124Z. For example, the received insights can be displayed in a table, a spreadsheet, a text document, etc., in a human-understandable fashion. In some embodiments, the insight component 117 can include a large language model that provides insights 144 that are in a text format, understandable by a human user of client device 120Z.

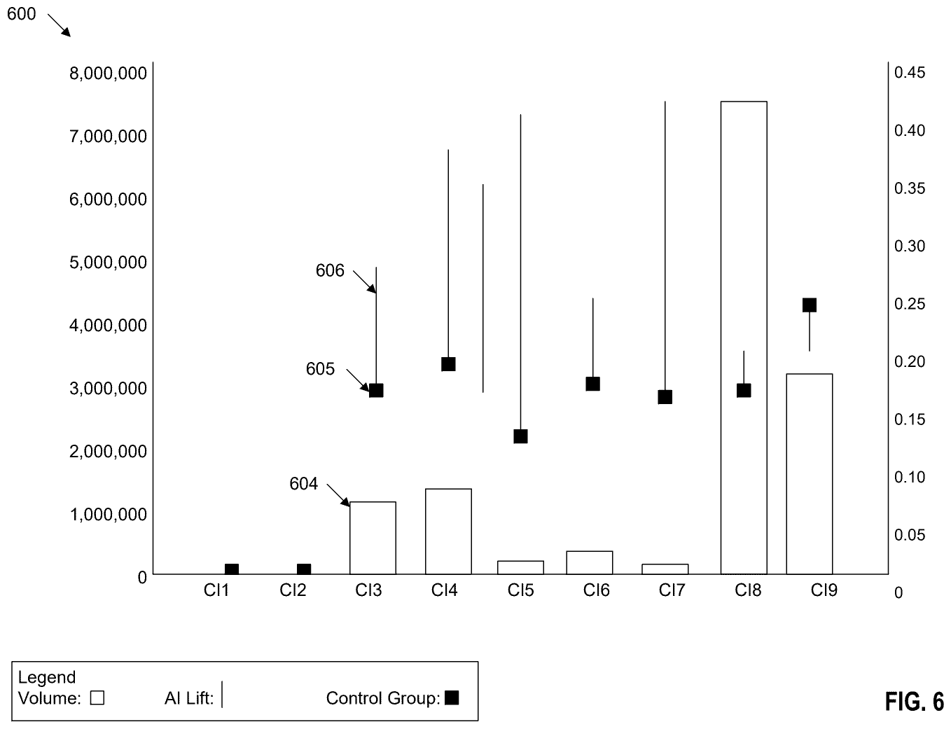

In some embodiments, insight visualization component 128 can generate graphs, charts, and/or other visual representations of the insights 144. In some embodiments, insight visualization component 128 can generate and/or display a graph and/or a chart (e.g., as illustrated in FIGS. 6-8). FIG. 6 illustrates an example candlestick chart 600 to show the individual performance of each content item, CI1-CI9, (in terms of conversion rate) with the AI turned on, as compared to the performance of each message in terms of conversion rate with the AI turned off (e.g., from the randomized control group). Chart 600 displays the feature or feature combinations of content items along the x-axis, and the conversion rate along the right-hand-side y-axis. The difference in the randomized conversions (AI-off, illustrated by the squares) and the solid line (AI-on) is the lift produced by the optimization within a particular time period. The lift refers to the upward movement of the conversion rate attributable to the optimization AI model.

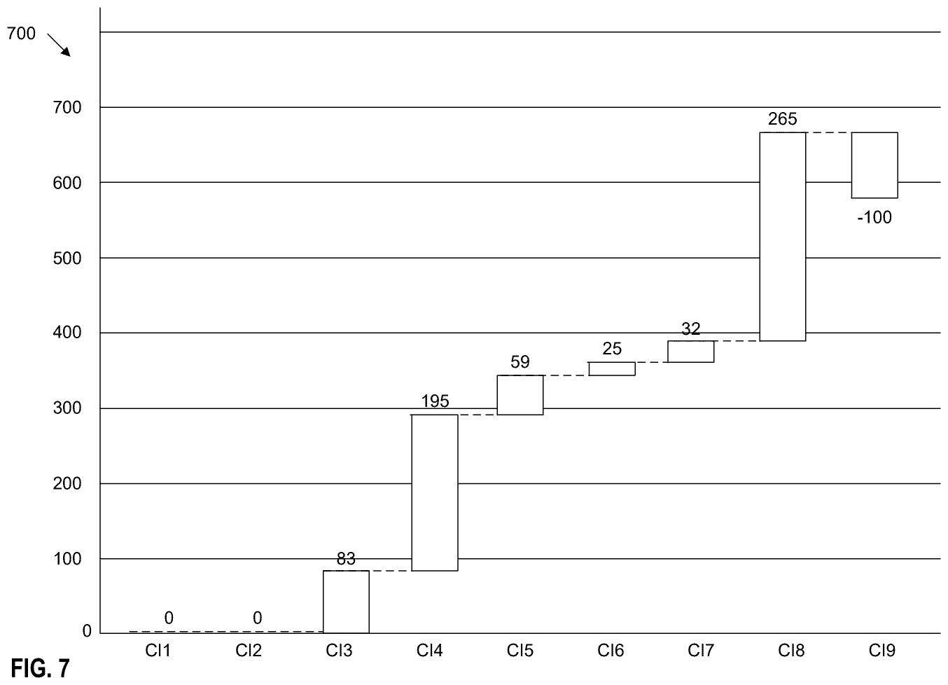

FIG. 7 illustrates an example waterfall chart 700, displaying AI's incremental lift over non-AI delivered content items. In some embodiments, the insight visualization component 128 can multiply the volume by the lift to show the total conversions by each content item (which can each include different features and/or feature combinations) in chart 700. The content items including various features and/or feature combinations are displayed along the x-axis of chart 700, and the total conversions are displayed along the y-axis of chart 700. The incremental lift refers to the incremental improvement in the displayed metric (e.g., the total conversions) between two points (e.g., between the total conversions with AI turned off and the total conversions with AI turned on). The incremental improvement can be attributed to the optimization AI model. Chart 700 illustrates the overall increase in the conversions, providing a visualization of the impact of the AI optimization on the conversions.

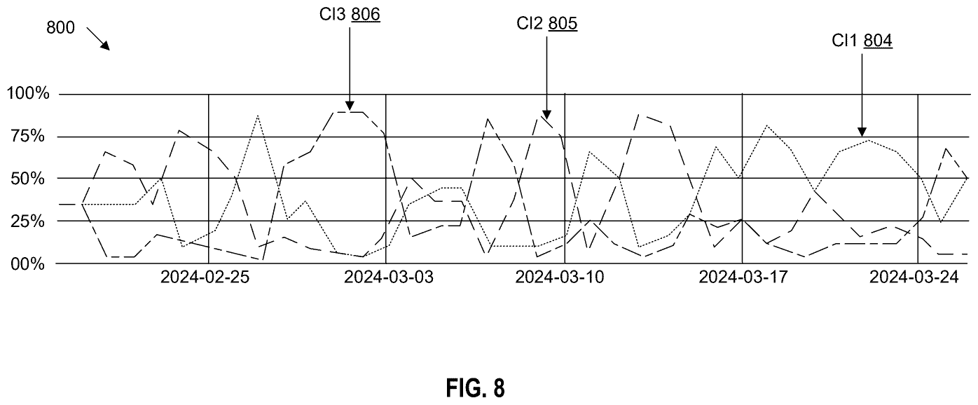

FIG. 8 illustrates an example time series chart 800 displaying the AI-adjusted allocation pattern over time for content items having certain features or feature combinations. As illustrated in FIG. 8, different features were used for a first set of content items CI1, a second set of content items CI2, and a third set of content items CI3, and the allocation of these sets of content items changed over time. The chart shows the percentages of content items with each of the different features over time. In some embodiments, the insight AI model can determine why specific content items were used more prevalently at different times, and may output explanations of such.

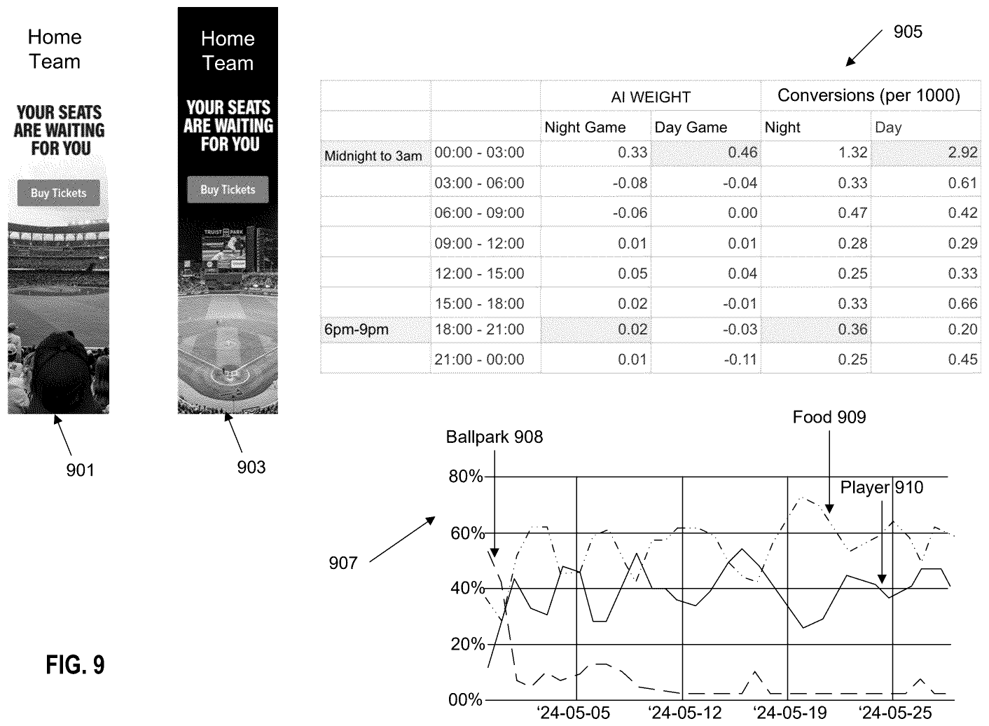

In some embodiments, the insight component 117 can determine the weights produced by the insight AI model. Weights are parameters within the insight AI model that transform the input data within the model's layers. The weights are adjusted during the training process to minimize errors in the model's predictions. The insight component 117 can use a combination of the weights from the insight AI model with the conversion rates from the time series allocation data as a baseline for interpreting the time series allocation data, as is further described with respect to FIG. 9. The conversion rate can be in terms of earnings per thousand impressions, for example. The insight display component 127 and/or insight visualization component 128 can use this baseline to generate charts 600, 700, and/or 800. In some embodiments, the insight component 117 can provide charts 600, 700, and/or 800 as input to the insight AI model (along with additional data, e.g., from news or events feeds, context data, and/or time series allocation data), and the insight AI model can output an explanation of time series allocation data (e.g., as provided by the optimization AI model).

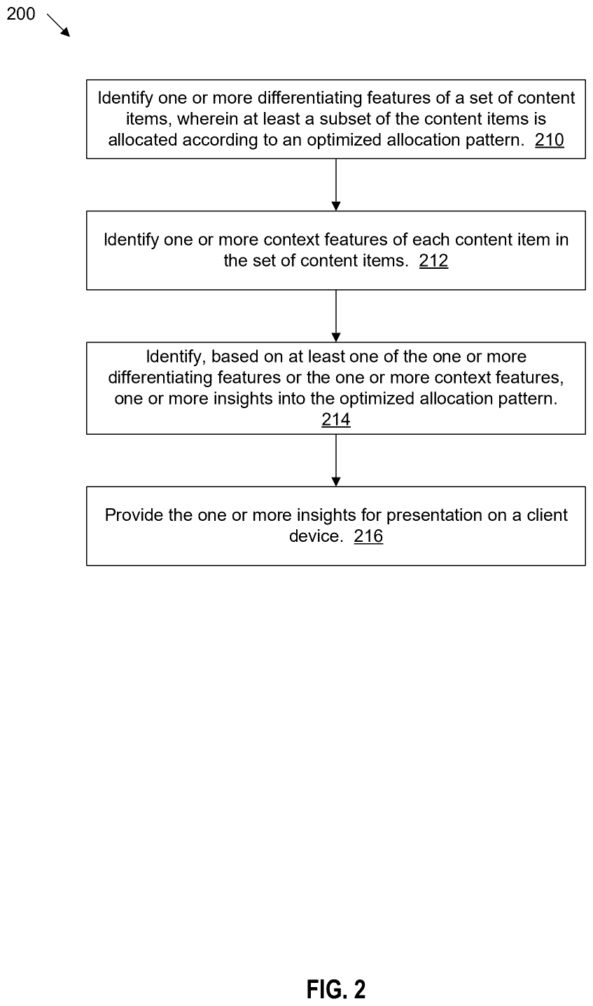

FIG. 2 depicts a flow diagram of a method 200 for identifying an insight into an optimized allocation pattern of a set of content items, in accordance with one or more aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 may be performed by the insight component 117 of FIG. 1. The method 200 may be executed by one or more processing devices of the server 112, to be presented to client devices 120A-120Z.

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification is capable of being stored on an article of manufacture (e.g., a computer program accessible from any computer-readable device or storage media) to facilitate transporting and transferring such method to computing devices.

At operation 210, the processing logic identifies one or more differentiating features of a set of content items, wherein at least a subset of the content items is allocated according to an optimized allocation pattern. In some embodiments, the optimized allocation pattern is optimized using an AI model, such as optimization AI model 151 of FIG. 1. In some embodiments, the differentiating features can correspond to differentiating features as described with respect to feature identifier 116 of FIG. 1. In some embodiments, the differentiating features can correspond to features data 143 of FIG. 1.

In some embodiments, the processing logic can implement a feature identifying AI model (e.g., feature identifying AI model 152 of FIG. 1) that identifies differentiating features of a set of content items. That is, to identify the one or more differentiating features of the set of content items, processing logic can provide, as input to a feature identifying AI model, the set of content items. The feature identifying AI model can be trained to identify at least one visual feature of a first content item of the set of content items that differs from the at least one visual feature of a second content item in the set of content items. The one or more differentiating features can include the at least one visual feature. In some embodiments, the feature identifying AI model can be a classifier (e.g., a trained machine learning model) that categorizes the content items into one or more classes according to differentiating feature(s). In some embodiments, the feature identifying AI model can be trained using a labeled dataset of content items, labeled with differentiating feature(s). In some embodiments, the feature identifying AI model can be a computer vision-based differentiation classifier. The feature identifying AI model can implement computer vision tasks to process and/or analyze the content items in the set of content items, in order to extract differentiating features between the content items in the set. Differentiating features can be visual features that differ between at least two content items in the set.

In some embodiments, the processing logic can identify differentiating features based on the data that corresponds to the content items in the set of content items. For example, each content item can have metadata that indicates the differentiating features included in the content item. In some embodiments, the content items can be generated based on one of multiple templates (e.g., templates 141 of FIG. 1), that each include different features (e.g., images, headlines, calls to action, background color, font, message content, etc.). Each content item can have a corresponding indicator that identifies one or more differentiating features (e.g., as discussed with regard to FIGS. 4,5). In some embodiments, the indicator can identify a particular template used. In some embodiments, the indicator can correspond to a feature combination, as described with respect to FIG. 4 or FIG. 5.

At operation 212, the processing logic identifies one or more context features of each content item in the set of content items, as described with respect to feature identifier 116 of FIG. 1. In some embodiments, the context features can be stored as context data 145 of FIG. 1. In some embodiments, the processing logic can implement a context AI model that is trained to provide contextual features for the set of content items. In some embodiments, the processing logic can provide, as input to the context AI model, data corresponding to at least one content item of the set of content items. The data can include, for example, a URL for a landing page to which clicking on a call-to-action button will lead the user, information on the organization(s) associated with the content item, etc. The context AI model can provide one or more context features for the set of content items. The context features can be stored as context data 145 of FIG. 1, for example. For example, the processing logic can provide the context AI model with the name of the organization(s) associated with the set of content items, and the context AI model can output information describing the organization(s). As another example, the processing logic can provide the context AI model with the website landing page of where a user's click-through leads (e.g., a URL), and the context AI model can output information gathered from the landing page. In some embodiments, the processing logic can provide the content of the set of the content items as input to the context AI model, and the context AI model can provide, as output, additional contextual information related to the set of the content items (e.g., the context AI model can identify a car in the content item, and can return information relating to cars, and/or to the specific make and model of the car in the set of content items). Each of these outputs can be context features of the corresponding content item. In some embodiments, the context AI model can be or include a large language model (LLM) that can synthesize the data corresponding to the at least one content item of the set of content items.

At operation 214, the processing logic identifies, based on at least one of the one or more differentiating features or the one or more context features, one or more insights into the optimized allocation pattern.

In some embodiments, processing logic provides, as input to an AI model (e.g., insight AI model 154 of FIG. 1), the at least one of the one or more differentiating features and/or the one or more context features of the optimized content items. The AI model outputs one or more insights into the optimized allocation pattern.

In some embodiments, the processing logic can identify one or more additional data items associated with the set of content items. The one or more additional data items can include data from a new feed and/or an events feed, for example. In some embodiments, the additional data items can correspond to additional time series data 146 of FIG. 1. In some embodiments, the one or more insights can be further based on the one or more additional data items. In some embodiments, the processing logic can provide, as additional input to the AI model, the one or more additional data items associated with the set content items (e.g., as described with respect to FIG. 1). The events feed can include a set of events (e.g., an events table) and corresponding event dates. In some embodiments, the processing logic can provide the optimized allocation pattern as input to the AI model.

In some embodiments, the AI model can be a generative AI model that is trained on a training data set. In some embodiments, the AI model is a pre-trained foundational model that is fine-tuned on a training data set. The training data set can include training inputs (e.g., including training content items, differentiating features, context features, additional data (e.g., news reports, events from an events feed), and/or time series allocation data for the content items), and target outputs (e.g., insights into the time series allocation data). The training data set can include mapping data that maps the training inputs to the target outputs. The AI model can be trained on the training data set. Once trained, the AI model can receive, as input, content items, differentiating features, context features, additional data (e.g., news reports, events), and/or time series allocation data for the content items, and can output insights into the time series allocation data. In some embodiments, the AI model can be a generative AI model, such as a large language model, that outputs human-understandable text providing reasoning behind the time series allocation data.

In some embodiments, the processing logic can identify time series data associated with the set of content items (e.g., corresponding to additional time series data 146 of FIG. 1). The time series data can include data from a news feed and/or an events log. Processing logic can identify one or more changes in the optimization allocation pattern that correlate with the time series data corresponding to a particular time window, and the one or more insights can be further based on the identified one or more changes.

At operation 216, the processing logic provides the one or more insights for presentation on a client device. In some embodiments, the processing logic can provide the one or more insights for display in a time series chart, e.g., as illustrated and described with respect to FIG. 8. In some embodiments, the one or more insights can be provided in image format and/or text format. For example, the processing logic can generate text (e.g., sentences, paragraphs, cells in a spreadsheet) that describes the one or more insights, and/or can generate an image (e.g., a chart, a graph, a calendar, etc.) that illustrates the one or more insights. In some embodiments, the processing logic can generate audio that describes the one or more insight(s).

In some embodiments, the processing logic identifies a second subset of the content items. The second subset is allocated according to a non-optimized allocation pattern. The processing logic compares a first performance result of the subset of content items to a second performance result of the second subset of content items. The performance results can be in terms of impressions, conversion rate, etc. Processing logic can identify an additional insight (or more) based on the comparison, and can provide the additional insight for presentation on the client device. In some embodiments, the processing logic can provide the additional insight(s) for display in candlestick chart (e.g., as illustrated and described with respect to FIG. 6), and/or in a waterfall chart (e.g., as illustrated and described with respect to FIG. 7). In some embodiments, the processing logic can generate text (e.g., sentences, paragraphs, cells in a spreadsheet) that describe the additional insight(s), and/or can generate an image (e.g., a chart, a graph, etc.) that illustrates the additional insight(s). In some embodiments, the processing logic can generate audio that describes the additional insight(s).

In some embodiments, the one or more insights are provided for presentation in the form of a chart or a graph, which can illustrate the first performance result of the subset of the set of content items and the second performance result of the second subset of content items. Examples of illustrations comparing the performance results of the first subset and the second subset are described with respect to FIGS. 6-7.

In some embodiments, the processing device can provide the one or more insights for display on a user device (e.g., user device 120Z of FIG. 1). The processing logic can generate and/or display a graph, chart, or other visual interpretation of the insight. Example charts are illustrated in FIGS. 6-8.

In some embodiments, the processing logic can generate, based on the one or more insights, one or more recommendations for future content item creation. The recommendation(s) can include specific feature combinations to use in the creation of new content items. The specific feature combinations can reflect the successful insights identified by insight component 117, for example. In some embodiments, the processing logic can provide the one or more recommendations for presentation on the client device.

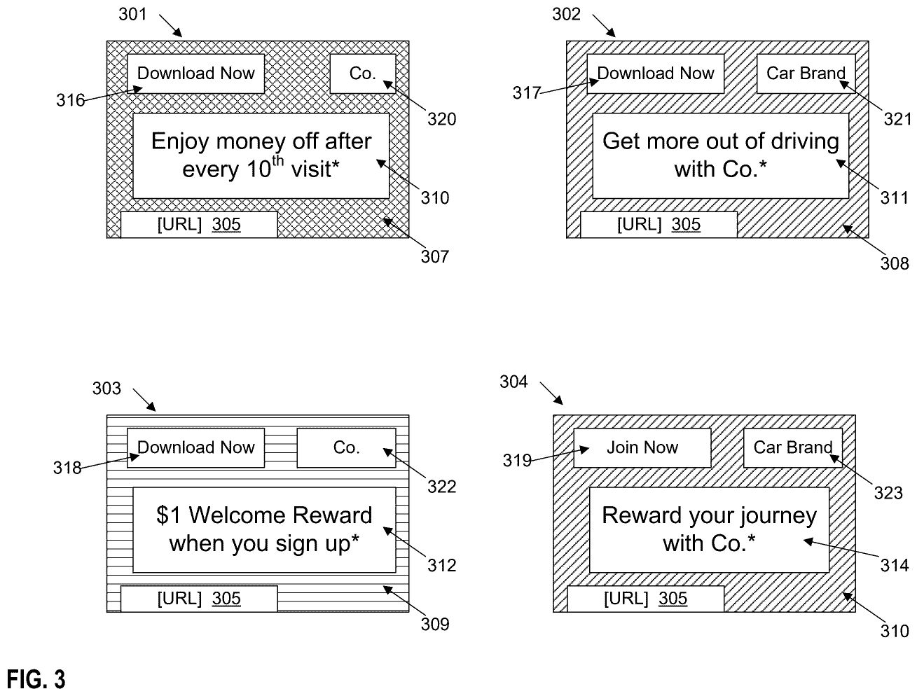

FIG. 3 illustrates example content items 301-304 with differentiating features, in accordance with one or more aspects of the present disclosure. The content items 301-304 may be part of a set of content items. Content items 301-304 can be content items within a set of content items for a promotional campaign, for example. Content items 301-304 can include one or more features that are the same throughout the set of content items, such as URL 305 included in the bottom left of each content item 301-304. Content items 301-304 can include one or more features that differ. For example, content items 302 and 304 can have the same background feature 306, but content items 301 and 303 can have a background features (307 and 309, respectively) that are different from each other and different from the background features (308 and 310) of content items 302 and 304. As another example, content items 301-304 can each include a different message feature 310-314. The placement of the message feature can be the same throughout each content item 301-304. Additional features may differ between the content items 301-304, such as the call-to-action features 316-319 and the co-sponsor logos 320-323. As illustrated in FIG. 3, the call-to-action feature 316-318 of content items 301-303 can be the same, while the call-to-cation feature 319 of content item 304 can differ from the other content items 301-303. Similarly, the co-sponsor logos 320, 322 of content items 301, 303 can be the same as each other, and the co-sponsor logos 321, 323 of content items 302, 304 can be the same as each other, but the co-sponsor logos 320, 322 can differ from the co-sponsor logos 321, 323. Thus, the differentiating features between the content items 301-304 illustrated in FIG. 3 can be the message features 310-314, the co-sponsor logo features 320-323, the call-to-action features 316-319, and the background features 307-310. The non-differentiating features can be, for example, the URL feature 305 and the placement of the features 305-323. Additional examples of features that can be differentiating can include font, font size, and/or font color of the text (e.g., the call-to-action text, the message text, and so on). Content items can include additional or fewer differentiating features than those listed herein. In some embodiments, feature identifier 116 can identify differentiating features in content items 301-304, including, for example, the background, the message, the call to action, the associated logo, etc., as described above.

In some embodiments, one or more of content items 301-304 may be identified (e.g., by an optimization AI model) for allocation within a particular time window (or at a particular time period) and/or for a particular user. The insight component 117 can use the identified differentiating features, the determined optimized allocation of content item, contextual data (e.g., data from the landing page to which clicking on the call to action will lead a user, information on the organization(s) associated with the content items 301-304, etc.), and/or additional data associated with the content items and the optimized allocation (e.g., news reports and/or events associated with the content of the content item 301-304, the geographic location of the optimized allocation, and/or the timing of the optimized allocation) to identify an insight into the pattern of the allocation of the content items 301-304, as further described throughout

FIG. 4 illustrates an example of a feature tree 400 for a set of content items, in accordance with one or more aspects of the present disclosure. In some embodiments, the feature tree 400 can be used to identify the various differentiating features of a set of content items. For example, feature identifier 116 of FIG. 1 can use the feature tree 400 to identify the differentiating features of the set of content items. The feature tree 400 can begin with a variety of template options 401 (e.g., corresponding to templates 141 of FIG. 1), where each template can have a variety of image options 420, each template-image combination can have a variety of headline options 450, and so forth. In some embodiments, each content item in the set of content items can be labeled (e.g., stored as metadata for each content item) that identifies each differentiating feature in the feature tree 400. For example, a content item that is generated using the second template, the first image, and the third headline can include an indicator/label in the metadata that indicates the first template, second image, and third headline (e.g., Template2, Image1, Headline3). In some embodiments, the feature tree 400 and/or the metadata of each content item can be provided to the insight AI model trained to provide insights into the pattern of the allocation of content items in the set of content items.

As illustrated in FIG. 4, content item 405 can correspond to a first template that includes background 408, the image 402 placed on the right-hand-side of the content item, the logo 406 placed on the top left of the content item, the headline 403 placed in the middle-left, and the call-to-action 414 placed under the headline 403; content item 410 can correspond to a second template that includes background 409, the image 411 that is placed in the upper two-thirds portion of the content item, the headline 412 and call-to-action 413 that overlay the image 411 on the left-hand-side of the content item, and the log 414 placed underneath the image 411; content item 415 can correspond to a third template that does not include a background but instead the image 416 takes up the entire content item, and the logo 419, headline 417, and call-to-action 418 overlay the image 416 on the left-hand-side of the content item. Thus, the three different templates of content items 405, 410, and 415 specify different placements of each feature.

The next level(s) of the feature tree 400 can specify different feature combinations. For example, the image 420 level of feature tree 400 specifies different images to use in each template. As illustrated in FIG. 4, content items 421, 431, and 441 each correspond to the second template, and each include a different image 426, 427, and 428, respectively. The other features of content items 421, 431, and 441 are consistent throughout. For example, each content item 421, 431, and 441 include the same headline 422, call-to-action 423, logo 424, and background 425, each located in the same place according to the second template. The next level of the feature tree 400 can identify which headline 450 to use, and so on. Each content item in a set of content items can have metadata that identifies which template-image-headline-etc. combination is used to generate the content item.

FIG. 5 illustrates an example feature grid 500 for a set of content items, in accordance with one or more aspects of the present disclosure. The feature grid 500 can be used to identify the various differentiating features of a set of content items, in a grid format. For example, feature identifier 116 of FIG. 1 can use the feature grid 500 to identify the differentiating features of the set of content items. As illustrated in FIG. 5, the differentiating features can include the image (e.g., image 1-3), the template (e.g., template 1-3), and the message (e.g., message 1-3). As an illustrative example, each content item 510-528 can be labeled (e.g., stored as metadata for each content item) as ImageX-TemplateY-MessageZ, to indicate the template-image-message combination for the particular content item. As an illustrative example, content item 510 can be labeled image 1-template1-message 1, and content item 527 can be labeled as image2-template3-message2. In some embodiments, the feature grid 500 and/or the metadata of each content item can be provided to the insight AI model trained to provide insights into the pattern of the allocation of content items in the set of content items.

FIG. 6 illustrates an example candlestick chart 600 to display the lift provided by AI, in accordance with one or more aspects of the present disclosure. The x-axis of chart 600 represents the features or feature combinations of the content items in the set of content items CI1-CI9. The feature combinations can be identified by feature identifier 116, using a trained feature identifying AI model and/or using metadata of the content items (e.g., from feature tree 400 of FIG. 4 and/or feature grid 500 of FIG. 5). The right-hand-side y-axis of chart 600 represents the performance of each content item (e.g., CI1-CI9) in terms of conversation rate. The left-hand-side y-axis of chart 600 represents the volume of each content item (e.g., CI1-CI9), illustrated as boxes. For example, box 604 indicates that the volume of content item 3 (CI3) at just under 1,500,000. The squares in chart 600 represent the performance of each message with the AI optimization turned off. That is, the squares in chart 600 represent the control group. For example, square 605 illustrates the performance of content item 3 (CI3) when delivered not using an AI optimized allocation is around 0.17. The solid lines in chart 600 represent the performance of each message with the AI optimization turned on. For example, solid line 606 illustrates the increase in performance of content item 3 (CI3) when delivered using an AI optimized allocation, which increased to around 0.28. Thus, chart 600 provides a visualization of the lift (or improvement) provided by the optimization AI model. For example, for content item 3 (CI3), the incremental lift in the performance of the content item due to AI optimization is approximately 0.11. In some embodiments, the insight visualization component 128 of FIG. 1 can generate chart 600 to illustrate the performance of various feature combinations represented in content items (e.g., content items CI1-CI9) when distributed using an AI-optimized allocation pattern compared to when distributed not using an AI-allocation pattern.

FIG. 7 illustrates an example waterfall chart 700 displaying incremental lift attributable to the AI optimization of the feature combinations in content items over content items that do not include AI-optimized feature combinations, in accordance with one or more aspects of the present disclosure. The x-axis of chart 700 represents the features or feature combinations of the content items in the set of content items, illustrated as content items CI1-CI9. The y-axis of chart 700 represents the number of conversion events. In some embodiments, insight component 117 and/or insight visualization component 128 can multiply the volume (as displayed on the y-axis of chart 600 of FIG. 1) by the lift (e.g., as displayed by the solid lines in FIG. 6) to show the total conversion events by each feature or feature combinations. The chart 700 provides a visualization of the lift (or improvement) provided by the optimization AI model, in waterfall form. For example, as illustrated in FIG. 7, the incremental lift for content item 3 is 83, and the incremental lift for content item 4 is 195.

FIG. 8 illustrates an example time series chart 800 displaying the AI-adjusted allocation pattern of content items over time, in accordance with one or more aspects of the present disclosure. The allocation pattern of content items is displayed on the y-axis, and the time is displayed on the x-axis. The allocation pattern of three content items is displayed in chart 800, including the dotted line 804 corresponding to a first content item (CI1), the dashed line 805 corresponding to a second content item (CI2), and the dot-dashed line 806 corresponding to a third content item (CI3). In some embodiments, the first content item CI1 can include a set of content items that include similar feature combinations, the second content item CI2 can include a set of content items that include similar feature combinations, and so on. As illustrated in chart 800, the allocation of the third content item CI3 started low and increased to a peak just before around Mar. 3, 2024, before returning to a relatively low allocation after Mar. 3, 2024, and peaking again halfway between March 3 and Mar. 10, 2024, and then remaining at around 25% or below until Mar. 24, 2024. As illustrated in chart 800, the allocation of the second content item CI2 started climbing early on and reached just over 75% before Feb. 25, 2024, before falling down to below 10% at around Mar. 3, 2024, and then peaking above 75% two more times, just before March 1 and between March 10 and Mar. 17, 2024. As illustrated in chart 800, the allocation of the first content item CI1 started neutral before climbing to 50% and then falling before Feb. 25, 2024, and then peaking to above 75% between February 25 and March 3, and continuing to go up and down until it remained at above 50% between March 17 and Mar. 24, 2024. The insight component 117, as described throughout, can provide insights to explain the allocation patterns illustrated in chart 800. As an illustrative example, the insight component 117 can provide insights to explain why the allocation of content item 1 (CI1) climbed just after February 25, and then remained below 50% until after March 10, for example. As another example, the insight component 117 can provide insights to explain why the allocation of content item (CI2) fell below 25% after Feb. 25, 2024, and then jumped to above 75% between March 3 and March 10, for example.

In some embodiments, the insight component 117 can use additional data (e.g., news reports and/or events corresponding to the timing of the allocation pattern) to identify insights into the allocation patterns 804-806. For example, the insight component 117 can identify, from news report(s), that the a particular car racing season started at the beginning of March 2024, which explains the first jump in the allocation of content items with features related to the car racing (e.g., illustrated as CI1) near the end of February 2024. As another example, a particular car race took place at the end of March 2024, which explains the second jump in the allocation of content items with features related to car racing (e.g., illustrated as CI1) near the end of March 2024. These are simplified examples to illustrate possible insights into the AI-adjusted allocation pattern of content items over time. In order to identify the insight into the pattern of the allocation, the insight component 117 can compare the date of an increase or decrease in the allocation pattern to the additional data (e.g., news reports and/or events, weather patterns, etc.) corresponding to the differentiating features of the content items in the allocation pattern. As an illustrative example, content items featuring a specific car brand jumped in late February 2024 and late March 2024, corresponding with news reports surrounding the beginning of the car racing season and a particular car race, respectively.

As another example, CI2 can include content items that each include the same image of a particular race car driver. The image can be a differentiating feature, e.g., differentiating the content items in CI2 from the content items in CI1 and CI3, for example. The content items with the differentiating feature of an image of a particular race car driver first spiked in February 2024 (e.g., illustrated as CI2 805). Insight component 117 can identify news reports and/or events from that time frame that correspond to the particular race car driver featured in the content items, and may identify an insight that the race car driver was admitted to the hospital during that time period. Thus, the admission of the race car driver to the hospital can explain why the optimizing AI model determined to allocate content items that included image(s) of the race car driver over other content items that did not include images of the race car driver.

FIG. 9 illustrates an example baseline interpretation of time series allocation data using weights and differential conversion rates, in accordance with one or more aspects of the present disclosure. As illustrated in FIG. 9, content items 901 and 903 depict two feature combinations for content items in a set of content items. Content item 901 includes a background image of a daytime baseball game, and content item 903 includes a background image of an evening baseball game. Other features in content items 901 and 903 are the same, such as the call-to-action (e.g., “Buy Tickets”), the message (e.g., “Your seats are waiting for you”), and the home team. In some embodiments, feature identifier 116 may have identified the background image as a differentiating feature. In some embodiments, the insight component 117 may identify AI weights from the optimization AI model given to each of the content item 901, 903, as displayed in table 905. As illustrated in FIG. 9, the AI weights are assigned in 3 hour increments, for each feature combination (here night game, illustrated as content item 903, and day game, illustrated as content item 901). Based on the AI weights, the insight component 117 can determine that the optimization AI model assigned more weight to the day game content time 901 during the midnight to 3 am time window, and assigned more weight to the night game content time 903 during the 6 pm-9 pm time window.

Additionally, the insight component 117 can identify the differential conversion rate for the content items 901, 903. As illustrated in table 905, the day game content item 901 had a higher differential conversion rate during the midnight to 3 am time window (e.g., the difference between the conversion rate of the day game content item 901 and the conversion rate of the night game content item 903 is greatest in the midnight to 3 am time window), and that the night game content item 903 had a higher differential conversion rate during the 6 pm-9 pm time window (e.g., the difference between the conversion rate of the night game content item 903 and the conversion rate of the day game content item 901 is greatest during the 6 pm-9 pm time window). Thus, the insight component 117 can use a combination of the AI weights and the differential conversion rates as a baseline to interpret the time series allocation data. In this example, the insight component 117 may interpret the time series allocation data based on the time of day and the differences in the feature combinations.

However, as illustrated in time series chart 907, the ballpark time-of-day feature 908 is not the only factor on which the output of the optimization AI model is based. Time series chart 907 illustrates the allocation of content items that include a particular ballpark feature 908, the allocation of content items that include a particular food feature 909, and the allocation of content items that include a particular player feature 910 over time (e.g., over the month of May 2024). While the AI weights and the conversion rate (including the differential conversion rates) provide a part of the reasoning of the time series allocation data, the insight component 117 can also provide additional input data to the insight AI model to generate an explanation of the reasoning behind the time series allocation data. As described above, the additional data can include news feeds (including news reports), events feed (including events and corresponding dates), and/or context data.

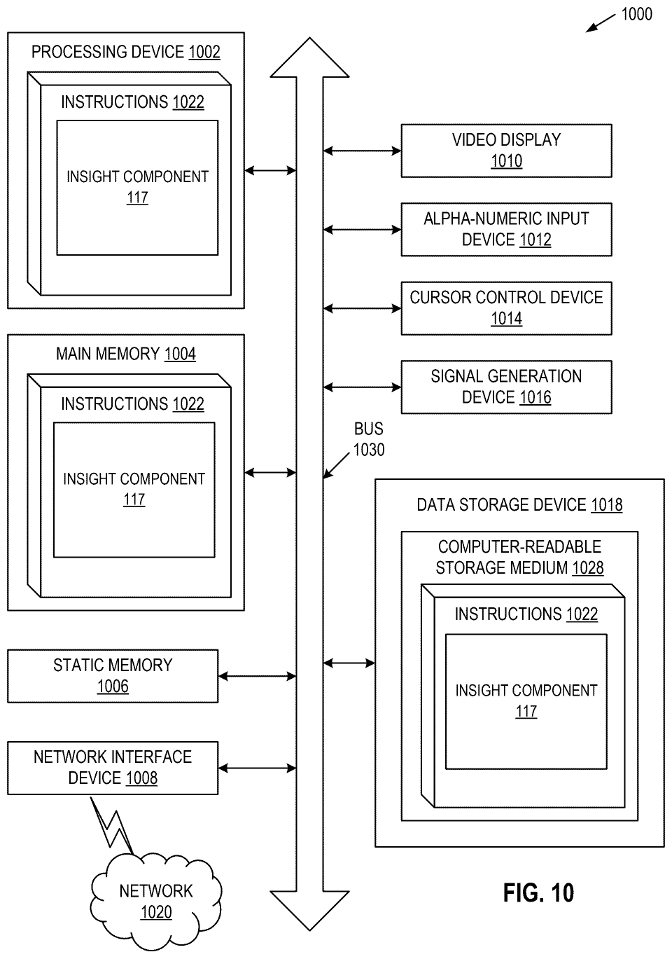

FIG. 10 depicts a block diagram of an example computing system 1000 operating in accordance with one or more aspects of the present disclosure. In various illustrative examples, computer system 1000 may correspond to any of the computing devices within system architecture 100 of FIG. 1. In one implementation, the computer system 1000 may be the server device 112.

In certain implementations, computer system 1000 may be connected (e.g., via a network, such as a Local Area Network (LAN), an intranet, an extranet, or the Internet) to other computer systems. Computer system 1000 may operate in the capacity of a server or a client computer in a client-server environment, or as a peer computer in a peer-to-peer or distributed network environment. Computer system 1000 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1000 may include a processing device 1002, a volatile memory 1004 (e.g., random access memory (RAM)), a non-volatile memory 1006 (e.g., read-only memory (ROM) or electrically-erasable programmable ROM (EEPROM)), and a data storage device 1016, which may communicate with each other via a bus 1008.

Processing device 1002 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1000 may further include a network interface device 1022. Computer system 1000 also may include a video display unit 1010 (e.g., an LCD), an alphanumeric input device 1012 (e.g., a keyboard), a cursor control device 1014 (e.g., a mouse), and a signal generation device 1020.

Data storage device 1016 may include a non-transitory computer-readable storage medium 1024 on which may store instructions 1026 encoding any one or more of the methods or functions described herein, including instructions implementing the insight component 117 of FIG. 1 for implementing the methods described herein.

Instructions 1026 may also reside, completely or partially, within volatile memory 1004 and/or within processing device 1002 during execution thereof by computer system 1000, hence, volatile memory 1004 and processing device 1002 may also constitute machine-readable storage media.

While computer-readable storage medium 1024 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “identifying”, “determining”, “generating”, “assigning”, “inputting”, “selecting”, “training”, “moving”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying one or more differentiating features of a set of content items, wherein at least a subset of the set of content items is allocated according to an optimized allocation pattern;
identifying one or more context features associated with the set of content items;
identifying, based on at least one of the one or more differentiating features or the one or more context features, one or more insights into the optimized allocation pattern; and
providing the one or more insights for presentation on a client device.

2. The method of claim 1, further comprising:
identifying one or more additional data items associated with the set of content items, wherein the one or more additional data items comprises data from at least one of a news feed or an events feed, and wherein the one or more insights are further based on the one or more additional data items.

3. The method of claim 1, further comprising:
identifying time series data associated with the set of content items, wherein the time series data comprises data from at least one of a news feed or an events log; and
identifying one or more changes in the optimization allocation pattern that correlate with the time series data corresponding to a time window, wherein the one or more insights are further based on the identified one or more changes.

4. The method of claim 1, wherein identifying the one or more insights into the optimized allocation pattern comprises:
providing, as input to an artificial intelligence (AI) model, the at least one of the one or more differentiating features or the one or more context features, wherein the AI model outputs the one or more insights into the optimized allocation pattern.

5. The method of claim 1, further comprising:
identifying a second subset of the set of content items, wherein the second subset of content items is allocated according to a non-optimized allocation pattern;
comparing a first performance result of the subset of content items to a second performance result of the second subset of content items;
identifying, based on the comparison, an additional insight; and
providing, for presentation on the client device, the additional insight.

6. The method of claim 5, wherein the one or more insights are provided for presentation in a form of at least one of a chart or graph, wherein at least one of the chart or the graph illustrates the first performance result of the subset of the set of content items and the second performance results of the second subset of the content items.

7. The method of claim 1, wherein identifying the one or more differentiating features of the set of content items comprises:
providing, as input to a trained AI model, the set of content items, wherein the trained AI model identifies at least one visual feature of a first content item of the set of content items that differs from the at least one visual feature of a second content item in the set of content items, wherein the one or more differentiating features comprises the at least one visual feature.

8. The method of claim 7, wherein the trained AI model is a computer vision-based differentiation classifier.

9. The method of claim 1, wherein identifying the one or more context features of each content item further comprises:
providing, as input to an AI model, data corresponding to at least one content item of the set of content items, wherein the AI model provides the one or more context features for the set of content items, and wherein the AI model comprises a large language model.

10. The method of claim 1, further comprising:
generating, based on the one or more insights, one or more recommendations for future content item creation; and
providing the one or more recommendations for presentation on the client device.

11. The method of claim 1, wherein the optimized allocation pattern is optimized using an AI model.

12. A system comprising:
a memory device; and
a processing device operatively coupled to the memory device, the processing device to execute instructions from the memory to perform a method to:
identify one or more differentiating features of a set of content items, wherein at least a subset of the set of content items is allocated according to an optimized allocation pattern;
identify one or more context features associated with the set of content items;
identify, based on at least one of the one or more differentiating features or the one or more context features, one or more insights into the optimized allocation pattern; and
provide the one or more insights for presentation on a client device.

13. The system of claim 12, wherein the method is further to:
identify time series data associated with the set of content items, wherein the time series data comprises data from at least one of a news feed or an events log; and
identify one or more changes in the optimization allocation pattern that correlate with the time series data corresponding to a time window, wherein the one or more insights are further based on the identified one or more changes.

14. The system of claim 12, wherein to identify the one or more insights into the optimized allocation pattern, the method is further to:
provide, as input to an artificial intelligence (AI) model, the at least one of the one or more differentiating features or the one or more context features, wherein the AI model outputs the one or more insights into the optimized allocation pattern.

15. The system of claim 12, wherein the method is further to:
identify a second subset of the set of content items, wherein the second subset of content items is allocated according to a non-optimized allocation pattern;
compare a first performance result of the subset of content items to a second performance result of the second subset of content items;
identify, based on the comparison, an additional insight; and
provide, for presentation on the client device, the additional insight, wherein the one or more insights are provided for presentation in a form of at least one of a chart or graph, wherein at least one of the chart or the graph illustrates the first performance result of the subset of the set of content items and the second performance results of the second subset of the content items.

16. The system of claim 12, wherein to identify the one or more differentiating features of the set of content items, the method is further to:
provide, as input to a trained AI model, the set of content items, wherein the trained AI model identifies at least one visual feature of a first content item of the set of content items that differs from the at least one visual feature of a second content item in the set of content items, wherein the one or more differentiating features comprises the at least one visual feature, wherein the trained AI model is a computer vision-based differentiation classifier.

17. The system of claim 12, wherein to identify the one or more context features of each content item, the method is further to:
provide, as input to an AI model, data corresponding to at least one content item of the set of content items, wherein the AI model provides the one or more context features for the set of content items, and wherein the AI model comprises a large language model.

18. The system of claim 12, wherein the method is further to:
generate, based on the one or more insights, one or more recommendations for future content item creation; and
provide the one or more recommendations for presentation on the client device.

19. A non-transitory computer-readable storage medium comprising instructions that, when executed by a processing device, cause the processing device to:
identify one or more differentiating features of a set of content items, wherein at least a subset of the set of content items is allocated according to an optimized allocation pattern;
identify one or more context features associated with the set of content items;
identify, based on at least one of the one or more differentiating features or the one or more context features, one or more insights into the optimized allocation pattern; and
provide the one or more insights for presentation on a client device.

20. The non-transitory computer-readable storage medium of claim 19, wherein the processing device is further to:
identify one or more additional data items associated with the set of content items, wherein the one or more additional data items comprises data from at least one of a news feed or an events feed, and wherein the one or more insights are further based on the one or more additional data items.
